(19) United States
(12) Patent Application Publication
(10) Pub. No.: US 2026/0189546 A1
(43) Pub. Date: Jul. 2, 2026

(54) MANAGING AUTHENTICATION INFORMATION IN TEXTUAL DATA FROM USER INPUT

(71) Applicant: International Business Machines Corporation, Armonk, NY (US)

(72) Inventors: Ian McPherson, Toronto (CA); Anthony Di Loreto, Markham (CA); Adrian Kalafut, Lucan (CA); Jason Koo, Markham (CA); Ethan Dain, Markham (CA)

(21) Appl. No.: 19/007,682

(22) Filed: Jan. 2, 2025

(51) Int. Cl. H04L 9/40

(52) U.S. Cl. CPC H04L 63/083

(57) ABSTRACT

A computer-implemented method for managing authentication information for a user. A processor set intercepts a user input entered by the user. The processor set transmits the textual data from the user input to a software tool for managing passwords in an encrypted fashion. The processor set generates a number of permutations based on the textual data from the user input. The processor set compares each permutation from the number of permutations to a list of passwords stored in the software tool to generate a number of comparisons. The processor set determines whether the textual data from the user input comprises authentication information for the user based on the number of comparisons. In response to determining that the textual data from the user input comprises authentication information for the user, the processor set alerts the user before the textual data from the user input is sent to the computer network.

### BACKGROUND

The disclosure relates generally to managing authentication information in textual data from user input.

Authentication information such as passwords are critical pieces of information used to verify identity of users attempting to access systems, applications, or data. Authentication information serves as the cornerstone of security mechanisms that ensure interaction between authorized individuals and protected systems, thereby protecting sensitive data, resources, and digital environments from unauthorized access.

Authentication information can take various forms based on the method of authentication employed. For example, knowledge-based data such as passwords relies on knowledges from users. In another example, possession-based authentication such as security tokens depends on what users have. In yet another example, biometric authentication such as retinal scans or voice patterns utilizes inherent characteristics unique to users.

The management and protection of authentication information are critical in mitigating security risks. Improperly handled authentication information such as weak passwords or exposed cryptographic keys, can lead to vulnerabilities that can be exploited by attackers. In other words, authentication information is vital because they protect against a variety of security threats such as unauthorized access to accounts, data breaches, and identity theft.

### SUMMARY

According to one illustrative embodiment, a computer-implemented method for managing authentication information for a user is provided. A processor set intercepts a user input entered by the user. The user input includes textual data to be sent to a computer network. The processor set transmits the textual data from the user input to a software tool for managing passwords in an encrypted fashion. The processor set generates a number of permutations based on the textual data from the user input using the software tool. The processor set compares each permutation from the number of permutations to a list of passwords stored in the software tool to generate a number of comparisons using the software tool. The processor set determines whether the textual data from the user input includes authentication information for the user based on the number of comparisons. In response to determining that the textual data from the user input includes authentication information for the user, the processor set alerts the user before the textual data from the user input is sent to the computer network. According to other illustrative embodiments, a computer system and a computer program product for managing authentication information for the user are provided.

### BRIEF DESCRIPTION OF THE DRAWINGS

FIG. 1 is a pictorial representation of a computing environment in which illustrative embodiments may be implemented;

FIG. 2 is an illustration of a block diagram of an authentication information management environment in accordance with an illustrative embodiment;

FIG. 3 is a flowchart of a process for managing authentication information in accordance with an illustrative embodiment;

FIG. 4 is a flowchart of a process for editing the textual data from the user input in accordance with an illustrative embodiment; and

FIG. 5 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

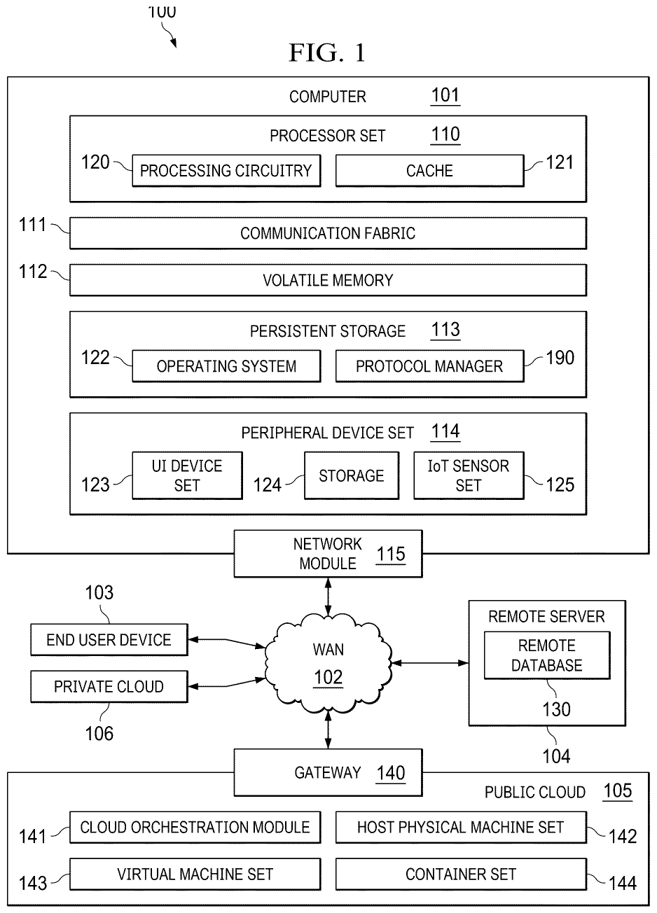

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as protocol manager 190. In addition to protocol manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and protocol manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in protocol manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in protocol manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that accidental leaks of authentication information pose a significant and recurring challenge in cybersecurity. The illustrative embodiments recognize and take into account that storing authentication information in plaintext within databases and sending that authentication information through unsecured communication channels, or sharing them via email can inadvertently expose sensitive authentication information to attackers.

The illustrative embodiments also recognize and take into account that one of the most common scenarios for accidental leaks of authentication information arise from human error. For example, an accidental leak of authentication information can occur via communications through social applications. In addition, the illustrative embodiments also recognize and take into account that it can be easy to type or paste sensitive information into the wrong window with multiple applications opened.

Thus, illustrative embodiments of the present invention provide a computer implemented method, computer system, and computer program product for managing authentication information for a user. In one illustrative example, a computer implemented method manages authentication information. A processor set intercepts a user input entered by the user. The user input includes textual data to be sent to a computer network. The processor set transmits the textual data from the user input to a software tool for managing passwords in an encrypted fashion. The processor set generates a number of permutations based on the textual data from the user input using the software tool. The processor set compares each permutation from the number of permutations to a list of passwords stored in the software tool to generate a number of comparisons using the software tool. The processor set determines whether the textual data from the user input includes authentication information for the user based on the number of comparisons. In response to determining that the textual data from the user input includes authentication information for the user, the processor set alerts the user before the textual data from the user input is sent to the computer network. According to other illustrative embodiments, a computer system and a computer program product for managing authentication information for the user are provided.

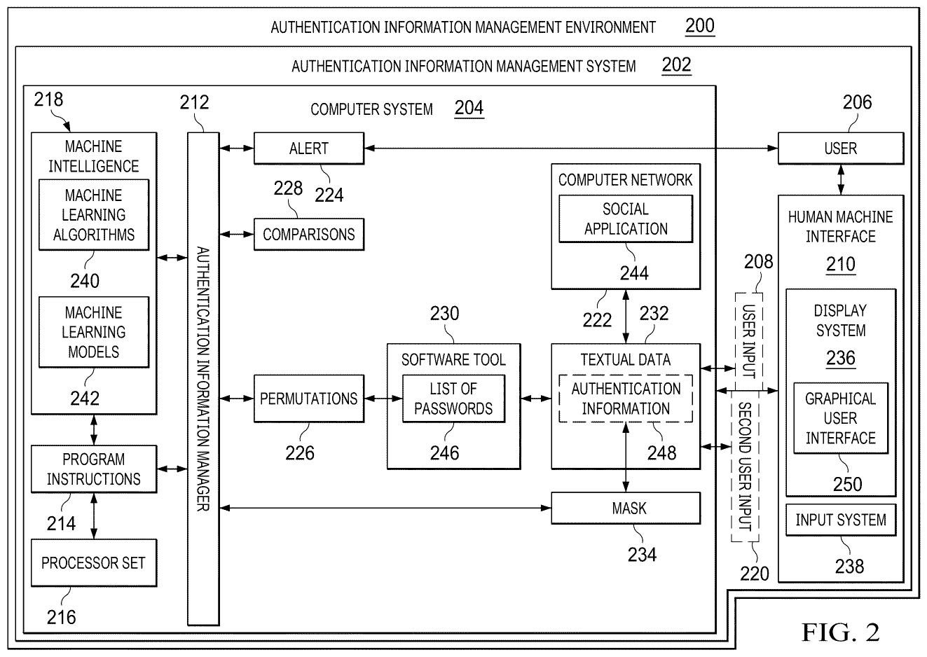

With reference now to FIG. 2, an illustration of a block diagram of an authentication information management environment is depicted in accordance with an illustrative embodiment. In this illustrative example, authentication information management environment 200 includes components that can be implemented in hardware such as the hardware shown in computing environment 100 in FIG. 1.

In this illustrative example, authentication information management system 202 in authentication information management environment 200 uses authentication information manager 212 to determine whether textual data 232 from user input 208 contains any authentication information that is confidential. In this illustrative example, authentication information management system 202 includes computer system 204 which includes authentication information manager 212. Authentication information manager 212 is located in computer system 204. Authentication information manager 212 may be implemented using protocol manager 190 in FIG. 1.

Authentication information manager 212 can be implemented in software, hardware, firmware, or a combination thereof. When software is used, the operations performed by authentication information manager 212 can be implemented in program instructions configured to run on hardware, such as a processor unit. When firmware is used, the operations performed by authentication information manager 212 can be implemented in program instructions and data and stored in persistent memory to run on a processor unit. When hardware is employed, the hardware can include circuits that operate to perform the operations in authentication information manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include machine learning models 242 and machine learning algorithms 240. Machine learning models 242 is a branch of artificial intelligence (AI) that enables computers to detect patterns and improve performance without direct programming commands. Rather than relying on direct input commands to complete a task, machine learning models 242 relies on input data. The data is fed into the machine, one of machine learning algorithms 240 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning so that products or assets that do not match descriptively can nevertheless be matched. Over time, the data model from machine learning can provide a greater degree of flexibility in matching machine intelligence 218.

Machine intelligence 218 can be implemented using one or more systems such as an artificial intelligence system, a neural network, a generative neural network, a Bayesian network, an expert system, a fuzzy logic system, a genetic algorithm, or other suitable types of systems. Machine learning models 242 and machine learning algorithms 240 may make computer system 204 a special purpose computer for determining whether textual data 232 from user input 208 contains authentication information that is confidential.

Machine learning models 242 involves using machine learning algorithms 240 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning algorithms 240 can include supervised machine learning algorithms and unsupervised machine learning algorithms. Supervised machine learning can train machine learning models using data containing both the inputs and desired outputs. Examples of machine learning algorithms include Gradient Boosting algorithm, Autogressive Integrated Moving Average (ARIMA), XGBoost, K-means clustering, and Random Forest algorithm.

In this illustrative example, machine learning models 242 can be retrained or updated using new data or outputs generated by machine learning models 242 such that parameters in machine learning algorithm selected for machine learning models 242 can be adjusted to improve accuracy and efficiency of machine learning models 242.

As depicted, authentication information manager 212 can be used to determine whether textual data 232 from user input 208 contains any confidential information. In this illustrative example, user 206 can interact with computer system 204 through user inputs to computer system 204. For example, computer system 204 can receive user input 208 that contains textual data 232 that is destinated to be sent to computer network 222. In this illustrative example, computer network 222 can be a communications medium that enables communications between different data processing systems in computer system 204. In this illustrative example, computer network 222 can be implemented using network module 115 in FIG. 1.

In this illustrative example, computer network 222 can include social application 244 for receiving textual data 232 from user input 208. In this illustrative example, social application 244 is a software or platform designed to facilitate social interactions and communications between users such as user 206. Social application 244 can provide features for sharing content, engaging in conversations, forming connections, and collaborating in real-time. In other words, social application 244 can be used for transmitting textual data 232 from user 206 to other users within computer network 222. In this illustrative example, social application 244 can be a social media application.

Textual data 232 includes information represented in written words, phrases, or sentences. Textual data 232 can be in various formats, for example, textual data 232 can be in plain text, structured format, or unstructured formats such as paragraphs, essays, and conversational contents.

In this illustrative example, user input 208 can be generated by user 206 using human machine interface (HMI) 210. As depicted, human machine interface 210 includes display system 236 and input system 238. Display system 236 is a physical hardware system and includes one or more display devices on which graphical user interface 250 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information. For example, user 206 can view textual data 232 through graphical user interface 250 as textual data 232 is being entered.

In this example, user 206 is a person that can interact with graphical user interface 250 through user input 208 generated by input system 238. Input system 238 is a physical hardware system and can be selected from at least one of a mouse, a keyboard, a touch pad, a trackball, a touchscreen, a stylus, a motion sensing input device, a gesture detection device, a data glove, a cyber glove a haptic feedback device, or some other suitable type of input device.

In this illustrative example, authentication information manager 212 intercepts textual data 232 before textual data 232 is sent to social application 244 within computer network 222. Authentication information manager 212 transmits textual data 232 to software tool 230 in an encrypted fashion after interception. In this illustrative example, textual data 232 can be encrypted in a number of ways. For example, textual data 232 can be hashed into permutations before transmitting to software tool 230.

Software tool 230 is software designed for managing authentication information such as passwords. In this illustrative example, software tool 230 is designed to securely store, organize and manage passwords and other sensitive information for user 206. Software tool 230 simplifies password management by allowing users to maintain unique, complex passwords for multiple accounts without having to memorize them all. In this example, software tool 230 can be a password manager such as LastPass and 1Password.

In this illustrative example, authentication information manager 212 uses software tool 230 to generate permutations 226 based on textual data 232. Permutations 226 are all possible arrangements or orders for a given set of elements including characters, words, or phrases from textual data 232. In other words, permutations 226 include every possible combination of characters, words, or phrases from textual data 232.

In this illustrative example, authentication information manager 212 compares permutations 226 to list of passwords 246 in software tool 230 to generate comparisons 228. List of passwords 246 is authentication information stored in software tool 230 for user 206. Authentication information manager 212 aims to determine whether any permutation from permutations 226 matches any authentication information from list of passwords 246. In this illustrative example, comparisons between permutations 226 and list of passwords 246 can be performed using machine learning models 242 from machine intelligence 218.

In this illustrative example, authentication information manager 212 determines whether textual data 232 includes authentication information 248 for user 206 based on comparison 228 generated from comparing permutations 226 with list of passwords 246. In this illustrative example, authentication information 248 can be passwords entered by user 206 through input system 238.

In this illustrative example, if authentication information 248 for user 206 cannot be identified from textual data 232 based on comparisons 228, authentication information manager 212 transmits textual data 232 to social application 244 and computer network 222 such that other users within computer network 222 can view textual data 232.

On the other hand, if authentication information 248 for user 206 is identified from textual data 232 based on comparisons 228, authentication information manager 212 sends alert 224 to user 206 such that user 206 is aware of the potential leak of confidential information from authentication information 248 in textual data 232. In this illustrative example, alert 224 can be used to prompt user 206 asking if user 206 would like to proceed with transmitting textual data 232 to social application 244. Alert 224 can be sent to user 206 through graphical user interface 250 in display system 236.

In an alternative example, authentication information manager 212 can detect authentication information 248 in textual data 232 through fuzzy searches. For example, authentication information manager 212 can use machine learning models 242 that understands what typical passwords look like for identifying if authentication information 248 is present in textual data 232.

In addition, user 206 can further provide second user input 220 to computer system 204 for editing textual data 232. In a similar fashion, second user input 220 can be generated by user 206 using human machine interface (HMI) 210. In this illustrative example, second user input 220 contains instructions related to how authentication information 248 can be edited such that potential leak of confidential information from user 206 can be prevented. Subsequently, authentication information manager 212 can transmit textual data 232 to social application 244 and computer network 222 after editing.

In an alternative example, authentication information manager 212 can automatically take action in response to detecting authentication information 248 in authentication information manager 212. For example, authentication information manager 212 can generate mask 234 for textual data 232 to hide authentication information 248 shown on graphical user interface 250 during a screen share that involves user 206 or before textual data 232 is transmitted to social application 244 and computer network 222.

In this illustrative example, authentication information manager 212 can generate a list of Uniform Resource Locator (URL) for trusted pages that can be stored in software tool 230. In this example, the URL will prevent authentication information manager 212 from intercepting user input 208 from user 206 with a pop-up as authentication information manager 212 knows that user 206 is entering password on a trusted page. In addition, authentication information manager 212 can also be designed to not intercept user input 208 from user 206 when user 206 is entering textual data into a password input field.

In an alternative example, features provided by authentication information manager 212 can also be integrated into software tool 230 or an operating system for computer system 204. In this illustrative example, features provided by authentication information manager 212 can be offered as a module linked with software tool 230 in the computer system. A new API from the operating system can be used by third-party social application such as social application 244. In an alternative example, the operating system can be linked to software tool 230 and monitor keystroke input to continuously check if inputs separated by spaces match anything in list of passwords 246.

As depicted, authentication information manager 212 can hash textual data 232 into permutations before transmitting to software tool 230. In this illustrative example, list of passwords 246 can include hashed version of all passwords it contains such that authentication information manager 212 can compare textual data 232 after hashing with hashed version of passwords in list of passwords 246 to determine whether authentication information 248 is present in textual data 232.

In one illustrative example, one or more solutions are present that overcome a problem with accidental exposure of authentication information from users while communicating with each other on a computer network. As a result, one or more technical solutions may provide an ability to improve the security of computer system 204 by preventing exposure of sensitive information that can be used to access to computer system 204.

Therefore, computer system 204 is configured to perform at least one of the steps, operations, or actions described in the different illustrative examples using software, hardware, firmware, or a combination thereof. As a result, computer system 204 operates as a special purpose computer system in which authentication information manager 212 in computer system 204 enables safeguards against accidental exposure of sensitive information. In particular, authentication information manager 212 transforms computer system 204 into a special purpose computer system as compared to currently available general computer systems that do not have an authentication information manager 212.

The illustration of authentication information management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, authentication information manager 212 can be used for authentication information other than textual data. For example, authentication information manager 212 can be used for biometric data, graphical data, or any suitable authentication data. In another example, authentication information manager 212 can be used for generating permutations 226 and perform comparisons 228 between permutations 226 with a list of known passwords without software tool 230. This feature is useful when software tool 230 does not support an Application Programming Interface (API) for performing comparisons.

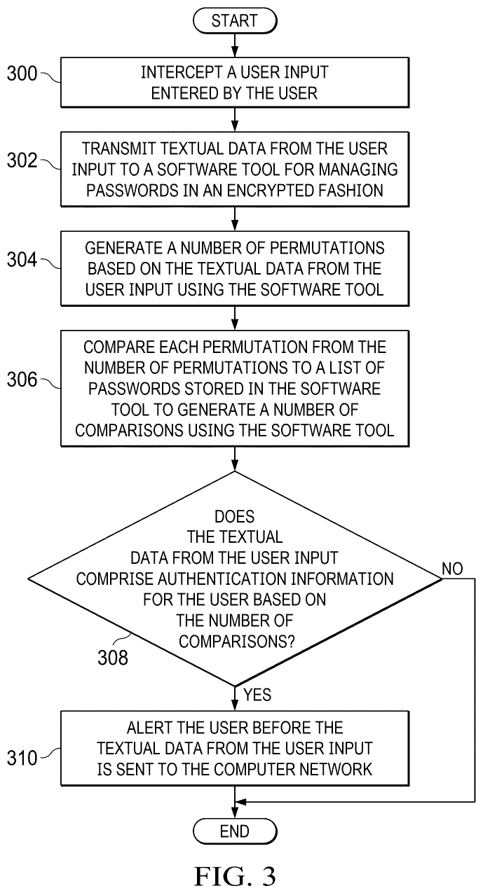

With reference now to FIG. 3, a flowchart illustrating a process for managing authentication information is shown in accordance with an illustrative embodiment. The process in FIG. 3 can be implemented in hardware, software, or both. When implemented in software, the process can take the form of program instructions that are run by one of more processor units located in one or more hardware devices in one or more computer systems. For example, the process can be implemented in authentication information manager 212 in computer system 204 in FIG. 2.

The process begins by intercepting a user input entered by the user (step 300). In step 300, the user input comprises textual data to be sent to a computer network. The process transmits textual data from the user input to a software tool for managing passwords in an encrypted fashion (step 302).

The process generates a number of permutations based on the textual data from the user input using the software tool (step 304). The process compares each permutation from the number of permutations to a list of passwords stored in the software tool to generate a number of comparisons using the software tool (step 306). The process determines whether the textual data from the user input comprises authentication information for the user based on the number of comparisons (step 308). If the textual data from the user input does not comprise authentication information for the user, the process terminates thereafter.

With reference again to step 308, if the textual data from the user input comprises authentication information for the user, the process alerts the user before the textual data from the user input is sent to the computer network (step 310). The process terminates thereafter.

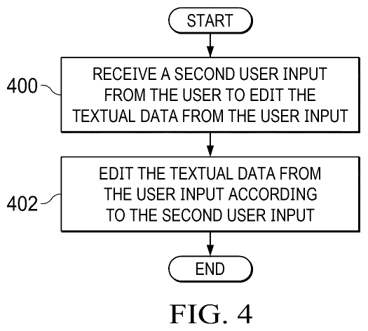

Turning next to FIG. 4, a flowchart of a process for editing the textual data from the user input is depicted in accordance with an illustrative embodiment. The process in this figure is an example of an additional step that can be performed with the steps in FIG. 3.

The process begins by receiving a second user input from the user to edit the textual data from the user input (step 400). The process edits the textual data from the user input according to the second user input (step 402). The process terminates thereafter.

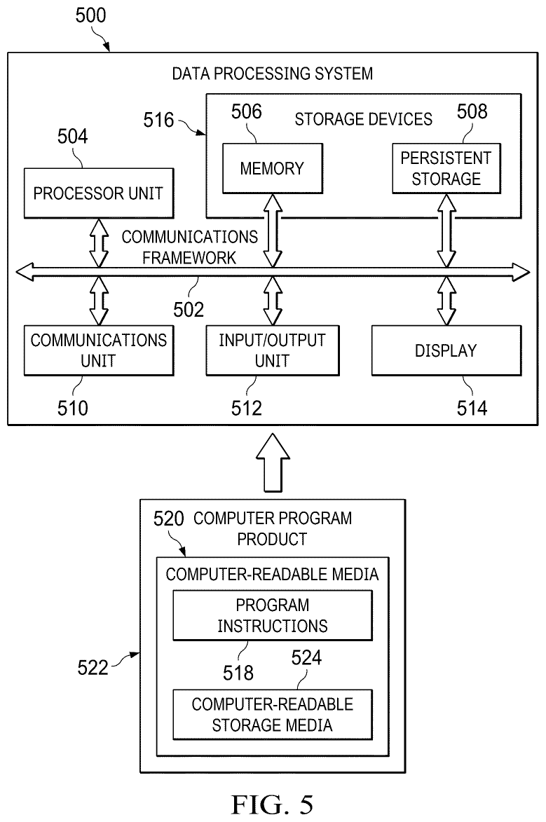

Turning now to FIG. 5, a block diagram of a data processing system is depicted in accordance with an illustrative embodiment. Data processing system 500 can be used to implement computers and computing devices in computing environment 100 in FIG. 1. Data processing system 500 can also be used to implement computer system 204 in FIG. 2. In this illustrative example, data processing system 500 includes communications framework 502, which provides communications between processor unit 504, memory 506, persistent storage 508, communications unit 510, input/output (I/O) unit 512, and display 514. In this example, communications framework 502 takes the form of a bus system.

Processor unit 504 serves to execute instructions for software that can be loaded into memory 506. Processor unit 504 includes one or more processors. For example, processor unit 504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 504 can be implemented using one or more heterogeneous processor systems in which a main processor is present with secondary processors on a single chip. As another illustrative example, processor unit 504 can be a symmetric multi-processor system containing multiple processors of the same type on a single chip.

Memory 506 and persistent storage 508 are examples of storage devices 516. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 516 may also be referred to as computer-readable storage devices in these illustrative examples. Memory 506, in these examples, can be, for example, a random-access memory or any other suitable volatile or non-volatile storage device. Persistent storage 508 may take various forms, depending on the particular implementation.

For example, persistent storage 508 may contain one or more components or devices. For example, persistent storage 508 can be a hard drive, a solid-state drive (SSD), a flash memory, a rewritable optical disk, a rewritable magnetic tape, or some combination of the above. The media used by persistent storage 508 also can be removable. For example, a removable hard drive can be used for persistent storage 508.

Communications unit 510, in these illustrative examples, provides for communications with other data processing systems or devices. In these illustrative examples, communications unit 510 is a network interface card.

Input/output unit 512 allows for input and output of data with other devices that can be connected to data processing system 500. For example, input/output unit 512 may provide a connection for user input through at least one of a keyboard, a mouse, or some other suitable input device. Further, input/output unit 512 may send output to a printer. Display 514 provides a mechanism to display information to a user.

Instructions for at least one of the operating system, applications, or programs can be located in storage devices 516, which are in communication with processor unit 504 through communications framework 502. The processes of the different embodiments can be performed by processor unit 504 using computer-implemented instructions, which may be located in a memory, such as memory 506.

These instructions are referred to as program instructions, computer usable program instructions, or computer-readable program instructions that can be read and executed by a processor in processor unit 504. The program instructions in the different embodiments can be embodied on different physical or computer-readable storage media, such as memory 506 or persistent storage 508.

Program instructions 518 are located in a functional form on computer-readable media 520 that is selectively removable and can be loaded onto or transferred to data processing system 500 for execution by processor unit 504. Program instructions 518 and computer-readable media 520 form computer program product 522 in these illustrative examples. In the illustrative example, computer-readable media 520 is computer-readable storage media 524.

Computer-readable storage media 524 is a physical or tangible storage device used to store program instructions 518 rather than a medium that propagates or transmits program instructions 518. Computer-readable storage media 524, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 518 can be transferred to data processing system 500 using a computer-readable signal media. The computer-readable signal media are signals and can be, for example, a propagated data signal containing program instructions 518. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 520” can be singular or plural. For example, program instructions 518 can be located in computer-readable media 520 in the form of a single storage device or system. In another example, program instructions 518 can be located in computer-readable media 520 that is distributed in multiple data processing systems. In other words, some instructions in program instructions 518 can be located in one data processing system while other instructions in program instructions 518 can be located in one data processing system. For example, a portion of program instructions 518 can be located in computer-readable media 520 in a server computer while another portion of program instructions 518 can be located in computer-readable media 520 located in a set of client computers.

The different components illustrated for data processing system 500 are not meant to provide architectural limitations to the manner in which different embodiments can be implemented. In some illustrative examples, one or more of the components may be incorporated in or otherwise form a portion of another component. For example, memory 506, or portions thereof, may be incorporated in processor unit 504 in some illustrative examples. The different illustrative embodiments can be implemented in a data processing system including components in addition to or in place of those illustrated for data processing system 500. Other components shown in FIG. 5 can be varied from the illustrative examples shown. The different embodiments can be implemented using any hardware device or system capable of running program instructions 518.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for managing authentication information for a user, the computer implemented method comprising:
intercepting, by a processor set, a user input entered by the user, wherein the user input comprises textual data to be sent to a computer network;
transmitting, by the processor set, the textual data from the user input to a software tool for managing passwords in an encrypted fashion;
generating, by the processor set using the software tool, a number of permutations based on the textual data from the user input;
comparing, by the processor set using the software tool, each permutation from the number of permutations to a list of passwords stored in the software tool to generate a number of comparisons;
determining, by the processor set, whether the textual data from the user input comprises authentication information for the user based on the number of comparisons; and
in response to determining that the textual data from the user input comprises authentication information for the user, alerting, by the processor set, the user before the textual data from the user input is sent to the computer network.

2. The computer implemented method of claim 1, further comprising:
in response to determining that the textual data from the user input does not comprise authentication information for the user, sending, by the processor set, the textual data to the computer network.

3. The computer implemented method of claim 1, further comprising:
receiving, by the processor set, a second user input from the user to edit the textual data from the user input.

4. The computer implemented method of claim 1, wherein the comparisons between each permutation from the number of permutations to a list of passwords stored in the software tool are performed using a machine learning model.

5. The computer implemented method of claim 1, wherein the computer network comprises a social application for receiving the textual data from the user input.

6. The computer implemented method of claim 1, wherein the textual data is hashed into permutations before transmitting to the software tool for managing passwords.

7. The computer implemented method of claim 1, wherein the textual data is masked on a graphical user interface during a screen share that involves the user.

8. A computer system for managing authentication information for a user, comprising:
a processor set;
a set of one or more computer-readable storage media; and
program instructions stored on the set of one or more storage media to cause the processor set to perform operations comprising:
intercept a user input entered by the user, wherein the user input comprises textual data to be sent to a computer network;
transmit textual data from the user input to a software tool for managing passwords in an encrypted fashion;
generate a number of permutations based on the textual data from the user input using the software tool;
compare each permutation from the number of permutations to a list of passwords stored in the software tool to generate a number of comparisons using the software tool;
determine whether the textual data from the user input comprises authentication information for the user based on the number of comparisons; and
in response to determining that the textual data from the user input comprises authentication information for the user, alerting the user before the textual data from the user input is sent to the computer network.

9. The computer system of claim 8, wherein the operations further comprise:
in response to determining that the textual data from the user input does not comprise authentication information for the user, sending the textual data to the computer network.

10. The computer system of claim 8, wherein the operations further comprise:
receiving, by the processor set, a second user input from the user to edit the textual data from the user input.

11. The computer system of claim 8, wherein the comparisons between each permutation from the number of permutations to a list of passwords stored in the software tool are performed using a machine learning model.

12. The computer system of claim 8, wherein the computer network comprises a social application for receiving the textual data from the user input.

13. The computer system of claim 8, wherein the textual data is hashed into permutations before transmitting to the software tool for managing passwords.

14. The computer system of claim 8, wherein the textual data is masked on a graphical user interface during a screen share that involves the user.

15. A computer program product, comprising:
a set of one or more computer-readable storage media;
program instructions stored in the set of one or more computer-readable storage media to perform operations comprising:
intercepting, by a processor set, a user input entered by a user, wherein the user input comprises textual data to be sent to a computer network;
transmitting, by the processor set, textual data from the user input to a software tool for managing passwords in an encrypted fashion;
generating, by the processor set using the software tool, a number of permutations based on the textual data from the user input;
comparing, by the processor set using the software tool, each permutation from the number of permutations to a list of passwords stored in the software tool to generate a number of comparisons;
determining, by the processor set, whether the textual data from the user input comprises authentication information for the user based on the number of comparisons; and
in response to determining that the textual data from the user input comprises authentication information for the user, alerting, by the processor set, the user before the textual data from the user input is sent to the computer network.

16. The computer program product of claim 15, wherein the operations further comprise:
in response to determining that the textual data from the user input does not comprise authentication information for the user, sending, by the processor set, the textual data to the computer network.

17. The computer program product of claim 15, wherein the operations further comprise:
receiving, by the processor set, a second user input from the user to edit the textual data from the user input.

18. The computer program product of claim 15, wherein the comparisons between each permutation from the number of permutations to a list of passwords stored in the software tool are performed using a machine learning model.

19. The computer program product of claim 15, wherein the textual data is hashed into permutations before transmitting to the software tool for managing passwords.

20. The computer program product of claim 15, wherein the textual data is masked on a graphical user interface during a screen share that involves the user.
